(19) United States
(12) Patent Application Publication
(10) Pub. No.: US 2006/0093333 A1
(43) Pub. Date: May 4, 2006

(54) Method for exchange of information between a mobile terminal and a server

(75) Inventors: Veronique Daurensan, Antony (FR); Guy Mathieu, Orsay (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/255,927

(22) Filed: Oct. 24, 2005

(30) Foreign Application Priority Data
Oct. 25, 2004 (FR) 0411374

(51) Int. Cl. H04N 5/91

(52) U.S. Cl. 386/106; 386/107

(57) ABSTRACT

The invention concerns methods of exchanging information between a mobile terminal and a server. It consists in a method comprising a step of sending at least one photo from a mobile terminal to a server, a step of the server analyzing the photo that has been sent, a step of associating with the photo that has been analyzed information relating to the content of the photo, and a step of sending the mobile terminal at least a portion of information associated with the photo. The mobile terminal supplies the server with additional information to assist the server to identify a subset of the photo and the server uses the additional information to identify a subset of the photo.

### CROSS-REFERENCE TO RELATED APPLICATIONS

This application is based on French Patent Application No. FR0411374 filed Oct. 24, 2004, the disclosure of which is hereby incorporated by reference thereto in its entirety, and the priority of which is hereby claimed under 35 U.S.C. §119.

### BACKGROUND OF THE INVENTION

1. Field of the invention

The invention concerns methods of exchanging information between a mobile terminal and a server. The user of the mobile terminal sends the photo of an object to a server which sends back information relating to the object. The exchange of information may continue and lead to a call enabling the user of the mobile terminal to receive from the server additional information relating to the object in the photo.

2. Description of the Prior Art

According to the prior art described in Chinese patent application CN1458613, there is known in the field of certification a method of sending a photo of a certification mark from a mobile terminal to a server that compares the photo to a pre-established base of certification marks and in return informs the mobile terminal if the certification mark is authentic or not. A drawback of the above prior art is that it is limited to one type of object to be compared identically with a set of references contained in a predefined database. Moreover, the response is of the yes/no type, and is therefore relatively impoverished. Once the object is no longer to be compared identically to a set of references in a predefined database, this prior art can no longer provide the user of the mobile terminal with information on the object in the photo.

The invention proposes that, in addition to the photo, the user of the mobile terminal provides additional information enabling the server to distinguish the pertinent object in the photo and therefore to be assisted in the selection of an appropriate database and where applicable to be able to supply the user of the mobile terminal with an enriched response better suited to the pertinent object, i.e. the object of interest to the user of the mobile terminal. Otherwise, a totally automatic shape recognition search without the slightest additional information from the user would lead the server to scan a large number of very large databases and to take too long analyzing the photo. The slight effort required of the mobile terminal user, which goes against the usual aim to make processes as automated as possible and to require the least effort on the part of the user, will be very productive for the mobile terminal user by obtaining a satisfactory response through the use of a reasonable level of resources and consequently within a reasonable response time and at a reasonable overall cost. Moreover, because a photo usually has a rich and complex content and the user of the mobile terminal is often interested in only one element or at the most a limited number of elements in the photo, if the user does not guide the server even slightly, there is the risk of the server being obliged to ask a large number of questions that are not pertinent to the mobile terminal user before targeting the user's requirement for information, which can hardly fail to annoy the user and make the service more of a nuisance for the user than useful to him.

### SUMMARY OF THE INVENTION

The invention provides a method comprising a step of sending at least one photo from a mobile terminal to a server, a step of the server analyzing the photo that has been sent, a step of associating with the photo that has been analyzed information relating to the content of the photo, and a step of sending the mobile terminal at least a portion of information associated with the photo, in which method the mobile terminal supplies the server with additional information to assist the server to identify a subset of the photo and the server uses the additional information to identify a subset of the photo.

To carry out the identification, the server first uses the additional information to highlight a subset of the photo and the server then identifies the subset that has been highlighted, preferably without the aid of additional information, but possibly with the aid of additional information. Another way to perform the identification is for the server simultaneously to highlight and identify a subset of the photo using the additional information.

The additional information and the photo(s) are preferably the only information supplied to the server by the mobile terminal user.

The invention also concerns a mobile terminal and a server that are particularly beneficial for implementing the method of the invention. The mobile terminal is preferably a mobile telephone.

The invention also provides a mobile terminal comprising an optical device for storing a photo, a device for sending the photo to a server, a device for receiving information from a server relating to the content of the photo that has been sent, and an input device, which may optionally be separate from the optical device, for capture by a user of the mobile terminal of additional information intended to assist the server to identify a subset of the photo that has been sent, the sender device being adapted to send the additional information to the server.

The invention further provides a server comprising a device for receiving a photo from a mobile terminal, a device for analyzing the photo that has been received and associating with the photo that has been analyzed information relating to the content of the photo that has been analyzed, and a device for sending to the mobile terminal at least a portion of information associated with the photo, and wherein the receiver device is adapted to receive from the mobile terminal additional information to assist the server to identify a subset of the photo and the analysis and association device is adapted to use the additional information to identify a subset of the photo

The invention will be better understood and other features and advantages of the invention will become apparent in the light of the following description and the appended drawing, which is provided by way of example.

### BRIEF DESCRIPTION OF THE DRAWING

FIG. 1 is a diagram of one example of a system utilizing the method of the invention.

### DETAILED DESCRIPTION OF THE PREFERRED EMBODIMENT

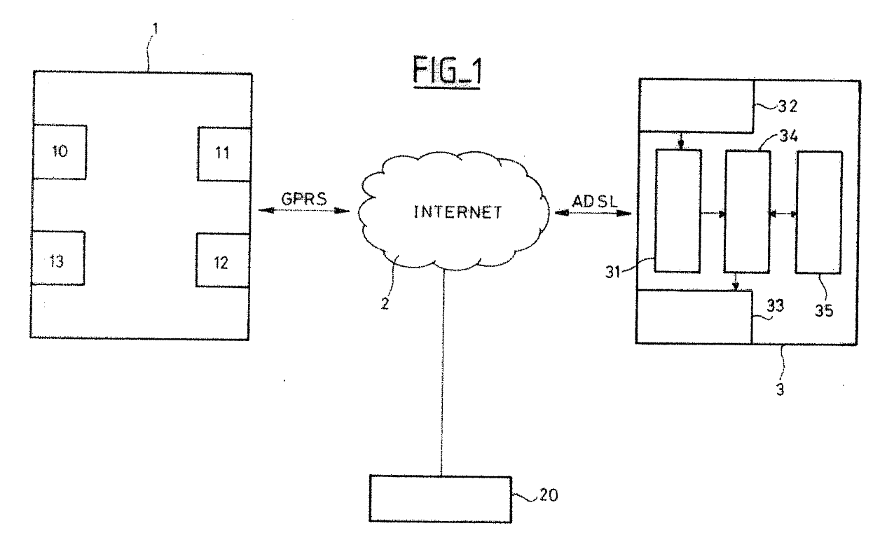

FIG. 1 is a diagram of one example of a system using the method of the invention. A mobile terminal 1 is connected to a server 3 via a communication network 2. The communication network 2 is an Internet type network. The mobile terminal 1 is a mobile telephone connected to the network 2 by a general packet radio service (GPRS) connection, for example. The server 3 is connected to the network 2 by an asymmetric data subscriber line (ADSL) connection, for example. The mobile terminal 1 and the server 3 communicate with each other via the network 2. The mobile terminal 1 comprises an optical device 10 for taking at least one photo, possibly a set of photos constituting a video, a receiver device 11, a sender device 12 and an input device 13. The server 3 comprises an analysis device 31, a receiver device 32, a sender device 33, an association device 34 and an information database 35.

The optical recording device 10 takes a photo. Additional information is entered by the user of the mobile terminal 1 via the input device 13. The sender device 12 of the mobile terminal 1 sends the photo and the additional information to the receiver device 32 of the server 3. The analysis device 31 analyzes the content of the photo with the aid of the additional information. To be more precise, the analysis device 31 identifies a subset of the photo by means of the additional information, in particular using shape recognition methods. Once the subset has been identified, the association device 34 associates an object with the identified subset, where applicable with the aid of databases containing reference objects. The object corresponds to the content of the identified subset. The association device 34 then associates information with that object, for example either with the assistance of a database 35 internal to the server 3 or by exchanging information with external databases 20 via the network 2 and using the receiver device 32 and the sender device 33. The information associated with the object is sent by the sender device 33 of the server 3 to the receiver device 11 of the mobile terminal 1. The user of the mobile terminal 1 can then access the information associated with the object.

In one embodiment, the additional information is in text form. It is a message which may comprise a single word, for example “animal”, that is sent by the mobile terminal to the server with a photo. The server then analyzes the various areas of the photo, looking for an animal, and ends up by recognizing a “lion” in a large yellow and brown area of the photo, for example. According to one option, this additional information in text form is sent in the form of a short message service (SMS) message. Another option is for the combination of the additional information in text form and the photo to be sent in the form of an MMS (multimedia message service) message.

In another embodiment, the additional information comprises a graphic mark in at least one area of the photo, enabling the server to highlight this area even before proceeding to identify it. For example, the user places a cursor on a white area of the photo, thus indicating to the server what is of interest to him in the photo, namely a white area corresponding to a statue representing the “Victory of Samothrace”, for example. In another example, the user frames a white area, for example by means of a square, to indicate in this way to the server that the object of interest to him is in this framed area, which contains the statue representing the “Victory of Samothrace”.

In another embodiment, the mobile terminal sends the server a plurality of photos in the form of video. The additional information comprises a voice message included in the soundtrack associated with the video. While the user on a safari films a troop of herbivores running across the Savannah, he says aloud that he is interested in “the animal with long horns”. The server then identifies the corresponding area of the photo, searches for an animal by comparison with the elements of a database on animals, and recognizes a sable antelope. The server can then send the mobile terminal the name of the animal (sable antelope) and detailed information about the animal.

In another embodiment, the additional information comprises a voice message sent by the user of the mobile terminal to the server during a telephone call between the mobile terminal and the server. Thus all the additional information assists the server to recognize an object in a photo quickly and correctly, at a low resource cost. For example, the user sends a photo asking for the “brown-looking mushroom” to be identified. The server then identifies the mushroom as a cep without difficulty, and tells the user, for example, that it is a cep, that it is edible, and even that it is delicious when cooked in an omelet.

In another embodiment, the additional information comprises a response to a multiple choice questionnaire sent to the mobile terminal by the server to guide the user, for example: Is the color of the object mostly green, yellow, red . . . ? Is the object a plant, animal, art object . . . ? Is the object on the right, the left, at the top, at the bottom? The server ends up by recognizing that the long dark spot on the right that represents an animal is a moray eel.

In another embodiment, the additional information is obtained via a predetermined request by means of which the server asks the user for certain information.

In another embodiment, the additional information may be given once and for all for a certain time period. For example: “I am at the Louvre all day, and I would like information on the artworks that the museum contains” or: “This week I am going on safari in Kenya and I would like information on all the animals that I am going to see”. By default, during the chosen time period, the server will always consider the same additional information, which makes it even easier for the mobile terminal user to use the service offered by the server. An option is for the user even to have the possibility of defining a user profile indicating his tastes, activities and interests to assist the server to identify objects contained in photos supplied by the mobile terminal user.

In one embodiment, the additional information is sent by the mobile terminal at the same time as the photo. The mobile terminal user has to make a little effort at the outset, but the server then operates quickly and efficiently. In another embodiment, the additional information is sent by the mobile terminal after a response from the server following sending of the photo. The response from the server could therefore guide the user through providing the additional information. The user has to make less effort, in that he can remain completely passive; however, this procedure will take slightly longer, because of the exchange of information between the mobile terminal and the server. Thus the server will need a little more time to obtain the additional information that it needs to analyze the photo.

A preferred option is for the method further to comprise a step of the server sending a “hint” to the mobile terminal, a step of the mobile terminal taking at least one additional photo under different conditions to the previous photo, those different conditions reflecting the hint, and a step of the mobile terminal sending the additional photo to the server. If the first photo is insufficient for the server to determine the object satisfactorily for the user, the hint might be, for example, a request to take another photo in different circumstances, for example: “change angle”, “go closer”, “switch on flash”, “zoom in”.

A preferred option is for the information associated with the photo to comprise a plan of action for the mobile terminal user. For example, the user sends the photo of a snake. The server can send him by way of information the name of the snake and the time remaining to get the user to hospital before the venom from a bite by the snake has irreversible effects such as the death of the victim, for example. The terminal of the invention may advantageously be combined with a kit of the main antidotes and in response to a photo of the snake the user receives the following information: “If bitten, inject the contents of syringe N° 3 immediately and get to a hospital within two hours”.

A preferred option is to determine the location of the mobile terminal, to enable the choice of a server that is geographically near the mobile terminal to reduce communications costs.

A preferred option is for the location of the mobile terminal to constitute at least part of the additional information. For example, if the mobile terminal user sends a photo to the server and if the server locates the user as being in the Louvre Museum, the server knows that the user will very probably ask for information on an artwork, and can by default analyze the photo by attempting to recognize directly one of the artworks in the Louvre. For example, if the mobile terminal user sends a photo to the server and the server locates the user at the Vincennes Zoo, the server knows that the user will very probably ask for information on an animal and can by default analyze the photo by attempting to recognize directly one of the animals at the Vincennes Zoo. For example, in the case of a photo of a bear at the Vincennes Zoo, the server can send the mobile terminal information on the animal, whereas in the case of a photo of a bear taken in a US national park, the server can send the mobile terminal, in addition to information on the animal, safety instructions to be followed because there the bears roam free.

A preferred option is for the information associated with the photo sent by the server to the mobile terminal to take the form of an HTML page, for example sent by mail. Applications of the method of the invention may be -varied and may concern, for example and in a manner that is not limiting on the invention, recognition of mushrooms and indication of their edibility or toxicity, recognition of animals and indication of their main characteristics such as size, weight, gestation period, habitat, etc, recognition of snakes and indication of the antidote to be injected in the event of a bite, recognition of artworks and monuments and indication of who created them, their time, etc.

1. A method comprising:
a step of sending at least one photo from a mobile terminal to a server,
a step of said server analyzing the photo that has been sent,
a step of associating with said photo that has been analyzed information relating to the content of said photo, and
a step of sending said mobile terminal at least a portion of information associated with said photo,
in which method:
said mobile terminal supplies said server with additional information to assist the server identify a subset of said photo, and
said server uses said additional information to identify a subset of said photo.

2. The method according to claim 1 wherein said additional information is in text form.

3. The method according to claim 2 wherein said additional information in text form is sent in SMS message form.

4. The method according to claim 2 wherein the set comprising said additional information in text form and said photo is sent in MMS message form.

5. The method according to claim 1 wherein said additional information comprises a graphical marking of at least one area of said photo.

6. The method according to claim 1 wherein said mobile terminal sends a plurality of photos to said server in video form and said additional information comprises a voice message included in the soundtrack associated with said video.

7. The method according to claim 1 wherein said additional information comprises a voice message sent by said user of said mobile terminal to said server during a telephone call between said mobile terminal and said server.

8. The method according to claim 1 wherein said additional information comprises a response to a multiple-choice questionnaire sent by said server to said mobile terminal.

9. The method according to claim 1, further including:
a step of said server sending a hint to said mobile terminal,
a step of said mobile terminal taking at least one additional photo under different conditions from the preceding photo, said different conditions reflecting said hint, and
a step of said mobile terminal sending said additional photo to said server.

10. The method according to claim 1 wherein said information associated with said photo comprises a plan of action for said user of said mobile terminal.

11. The method according to claim 1 wherein determining the location of said mobile terminal enables the choice of a server geographically close to said mobile terminal.

12. The method according to claim 1 wherein the location of said mobile terminal constitutes at least a portion of said additional information.

13. The method claimed in claim 1 wherein said information associated with said photo sent by said server to said mobile terminal takes the form of an HTML page.

14. The method according to claim 1 wherein said mobile terminal sends said additional information at the same time as said photo.

15. The method according to claim 1 wherein said mobile terminal sends said additional information after a response from said server following the sending of said photo.

16. The method according to claim 1 wherein said server first uses said additional information to highlight a subset of said photo and said server thereafter identifies the subset that has been highlighted.

17. The method according to claim 1 wherein said server simultaneously highlights and identifies a subset of said photo using said additional information.

18. The method according to claim 1 wherein said additional information and said photo(s) are the only information supplied to said server by said mobile terminal user.

19. A mobile terminal comprising:
an optical device for storing a photo,
a device for sending said photo to a server,
a device for receiving information from a server relating to the content of the photo that has been sent,
wherein
said an input device, which may optionally be separate from said optical device, for capture by a user of said mobile terminal of additional information intended to assist said server to identify a subset of said photo that has been sent, and
said sender device is adapted to send said additional information to said server.

20. A server comprising:
a device for receiving a photo from a mobile terminal,
a device for analyzing the photo that has been received and associating with the photo that has been analyzed information relating to the content of said photo that has been analyzed, and
a device for sending to said mobile terminal at least a portion of information associated with said photo,
and wherein:
said receiver device is adapted to receive from said mobile terminal additional information to assist said server to identify a subset of said photo, and
said analysis and association device is adapted to use said additional information to identify a subset of said photo.
